(19) United States
(12) Patent Application Publication
(10) Pub. No.: US 2004/0212912 A1
(43) Pub. Date: Oct. 28, 2004

(54) Method and apparatus for detecting sync mark in a disk drive

(75) Inventors: Yutaka Okamoto, Mitaka-shi (JP); Manabu Akamatsu, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/796,169

(22) Filed: Mar. 10, 2004

(30) Foreign Application Priority Data
Apr. 23, 2003 (JP) 2003-118463

(51) Int. Cl. G11B 19/02; G11B 5/09

(52) U.S. Cl. 360/72.1; 360/39

(57) ABSTRACT

A disk drive is disclosed which has a read channel reproducing user data from a data field synchronously with a sync mark detected in binary data obtained from a read signal. The read channel has a SYNC detection unit including a facility to predict the position of the sync mark utilizing the read signal. The SYNC detection unit predicts and detects the position of the sync mark in accordance with a preamble end signal.

### CROSS-REFERENCE TO RELATED APPLICATIONS

This application is based upon and claims the benefit of priority from prior Japanese Patent Application No. 2003-118463, filed Apr. 23, 2003, the entire contents of which are incorporated herein by reference.

### BACKGROUND OF THE INVENTION

1. Field of the Invention

The present invention generally relates to the field of disk drives, and in particular, to detection of a sync mark required to reproduce data.

2. Description of the Related Art

In general, in a disk drive, typified by a hard disk drive, data is recorded on a rotating disk medium by sector format using, as units, data fields (data recording areas) called sectors.

The sector format involves not only the data fields, in which user data is recorded, but also sync mark areas each located adjacent to a leading portion of the corresponding data field. A data pattern (sync pattern) called a sync mark is recorded in each sync mark area. The sync mark area is provided to detect the leading portion of the corresponding data field.

In the disk drive, data encoded using predetermined channel codes is recorded in each data field. If a read channel is to reproduce data read from the data field, original user data is restored by decoding the data while separating it into channel codes. The sync mark is used to detect the leading position of the channel codes.

A method of detecting such a sync mark has been proposed (refer to, for example, U.S. Pat. No. 5,243,471). This method comprises providing a detection window covering a section containing a position expected to have a sync mark recorded in it and comparing a bit string of channel data detected in this detection window with a bit pattern corresponding to the sync mark.

With the method of detecting a sync mark according to the above prior art technical document, it is difficult to improve the accuracy of prediction of the position of a sync mark owing to a variation in the rotation of the disk medium. Thus, mistakes are likely to occur in detecting the sync mark.

### BRIEF SUMMARY OF THE INVENTION

In accordance with one embodiment of the present invention, there is provided a disk drive including facilities to detect a sync mark by accurately predicting its position.

The disk drive comprises a disk medium; a read head which reads a read signal from the disk medium, the read signal containing data recorded in a data field on the disk medium and a sync pattern used to detect a leading position of the data field; a binary data generation unit which generates a binary data sequence from the read signal, the binary data sequence corresponding to the data and the sync pattern; and a sync detection unit which uses the read signal to determine the leading position of the sync pattern and detects the sync pattern in the binary data sequence in accordance with a result of the detection.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing essential parts of a disk drive according to an embodiment of the present invention;

FIG. 2 is a diagram showing a sector format according to the present embodiment;

FIG. 3 is a block diagram showing the configuration of a timing generation unit according to the present embodiment;

FIG. 4 is a block diagram showing the configuration of a mode phase comparison unit according to the present embodiment;

FIG. 5 is a block diagram showing the configuration of a SYNC detection unit according to the present embodiment;

FIG. 6 is a block diagram showing the configuration of a SYNC position prediction unit according to the present embodiment;

FIG. 7 is a block diagram showing the configuration of a SYNC mark pattern detection unit according to the present embodiment;

FIGS. 8A to 8C are timing charts illustrating operations of an acquisition mode phase comparison unit according to the present embodiment;

FIGS. 9A to 9H are timing charts illustrating operations of the SYNC detection unit according to the present embodiment;

FIG. 10 is a block diagram showing essential parts of a disk drive according to another embodiment;

FIG. 11 is a block diagram showing the configuration of a SYNC position prediction unit according to this embodiment; and

FIG. 12 is a diagram showing a sector format according to this embodiment.

### DETAILED DESCRIPTION OF THE INVENTION

Embodiments of the present invention will be described below with reference to the drawings.

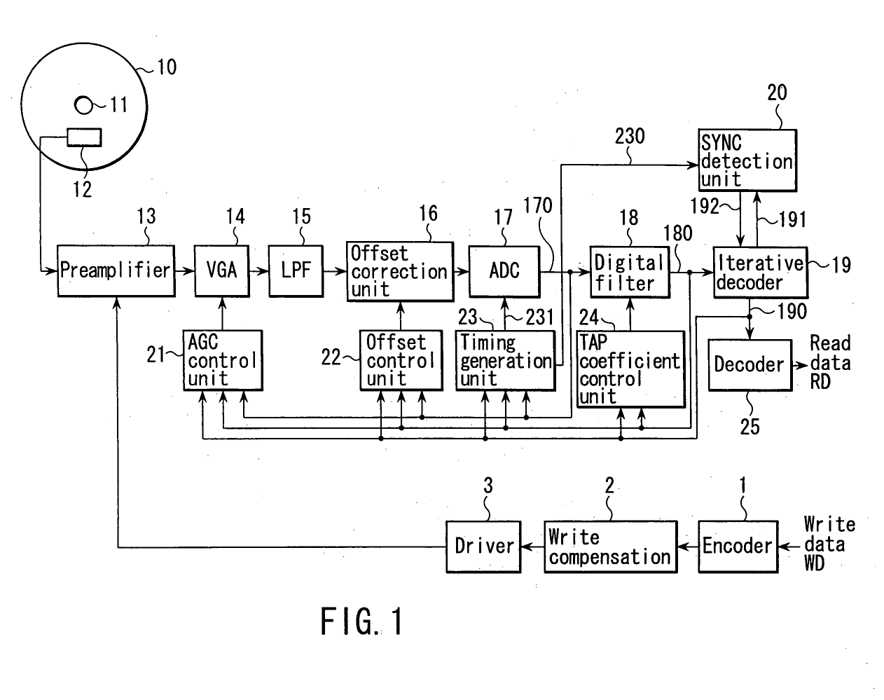

FIG. 1 is a block diagram showing essential parts of a disk drive according to the present embodiment.

(Configuration of Read Channel)

As shown in FIG. 1, a disk drive has a disk medium 10 that is a data recording medium, a read/write head 12, and a read/write channel. The disk medium 10 is rotated by a spindle motor 11. The read/write head 12 has a read head that performs a data read operation on the disk medium 10 and a write head that performs a data write operation on the disk medium 10. The read and write heads are mounted on the same slider so as to be separated from each other.

The read/write channel is composed of a write channel that executes signal processing of write data WD and a read channel that processes a read signal read from the read head to reproduce corresponding read data RD.

The write channel has an encoder 1, a write compensator 2, and a driver 3.

The encoder 1 normally encodes write data WD transferred by a host system into a channel code sequence that is composed of, for example, RLL (Run Length Limited) codes. The write compensator 2 executes, on the channel code sequence, write compensation such as the correction of timing for a recording signal waveform. The driver 3 converts the channel code sequence subjected to the write compensation, into a write current and outputs the write current to a preamplifier circuit 13.

The write head writes data (channel code sequence) to the disk medium 10 in accordance with a write current outputted by a write amplifier included in the preamplifier circuit 13.

To reproduce data, the read head reads a read signal from the disk medium 10 and outputs the signal to the preamplifier circuit 13. A read amplifier included in the preamplifier circuit 13 amplifies and transfers the read signal to the read channel.

The read channel has a variable gain amplifier (VGA) 14, a low pass filter (LPF) 15, an offset adjustment unit 16, an A/D converter 17, an FIR (Finite Impulse Response) type digital filter 18, an iterative decoder 19, a SYNC detection unit 20, and a channel decoder 25.

The VGA 14 has its gain controlled by an AGC (Automatic Gain Controller) 21 to control the amplitude of the read signal amplified by the read amplifier of the preamplifier circuit 13 so that the amplitude is kept constant. The read signal has its amplitude value varied by, for example, a variation in read position on the disk medium 10 which position is taken by the read head, a variation in the amount of floatation of the head 12, or a variation in write conditions during data recording.

The LPF 15 is an analog filter that suppresses a noise band contained in a read signal waveform. The offset adjustment unit 16 corrects the offset of a read signal (deviation of a zero level) in accordance with control provided by the offset control unit 22. An offset may occur in the waveform of the read signal owing to a shift in a base line caused by the inhibition of a low frequency component or a transient that may occur when the read head shifts from a servo signal area to a user data area.

The A/D converter 17 converts a read signal with an analog signal waveform into a digital signal sequence 170 synchronously with a timing clock (sampling clock) 231 outputted by a timing generation unit 23, described later. The digital signal sequence 170 is obtained by converting the amplitude value of the read signal into a quantized discrete-time sample value sequence using a reproduction clock that synchronizes with a channel clock for written data.

The timing generation unit 23 is a timing recovery circuit that synchronizes the channel clock for data written on the disk medium 10 to the reproduction clock (sampling clock 231).

In accordance with control provided by a TAP coefficient control unit 24, the digital filter 18 executes a waveform equalization process on the digital signal sequence 170 outputted by the A/D converter 17 so as to obtain a target waveform for a PR (Partial Response) system. The iterative decoder 19 receives a digital signal waveform 180 PR-equalized by the digital filter 18 as an input and decodes it into a binary data sequence (a bit string of binary data). The channel decoder 25 decodes the binary data sequence 190 into original write data WD.

The SYNC detection unit 20 detects a sync mark (sync pattern) in the binary data sequence (bit string of binary data) 191, outputted by the iterative decoder 19, and outputs a corresponding detection signal 192 (indicating the leading position of the channel codes).

(Sector Format)

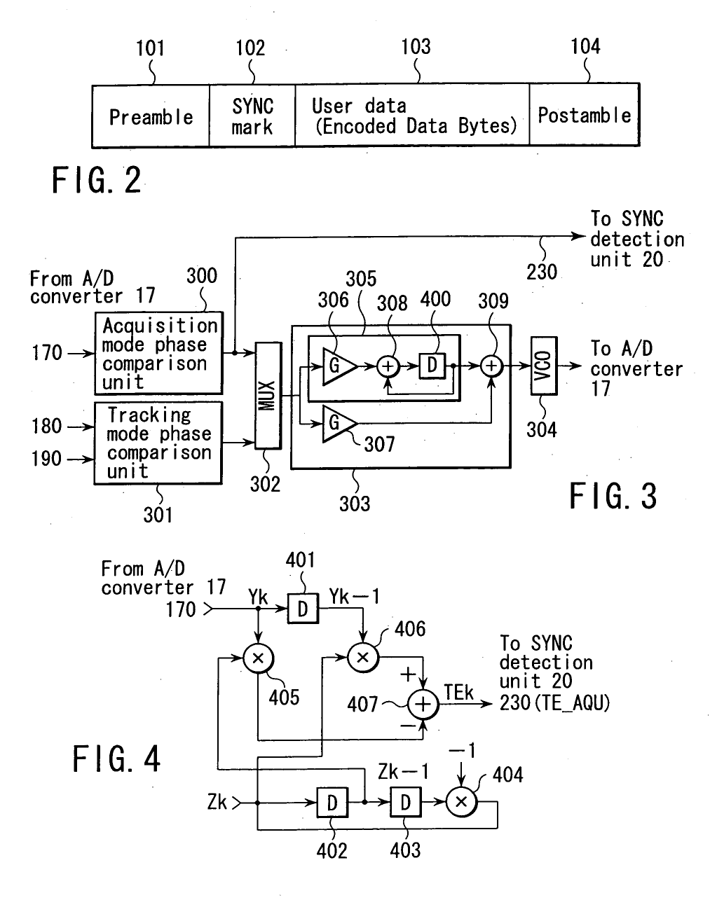

In the disk drive, data is recorded on the disk medium 10 using, as units, sectors such as those shown in FIG. 2. Normally, a large number of tracks are formed on the disk medium 10 and are each divided into a plurality of sectors.

As shown in FIG. 2, a sector format is roughly composed of a preamble area 101, a sync mark area 102, a data field (data recording area) 103, and a postamble area 104.

A synchronous signal (a preamble pattern) with a single frequency used in what is called a PLL (Phase-Locked Loop) circuit is recorded in the preamble area 101. The postamble area 104 is an adjustment area used to absorb a variation in the rotation of the disk medium 10.

A sync mark (a sync pattern) is recorded in the sync mark area 102 to detect the leading portion of the data field 103. The SYNC detection unit 20 detects the sync pattern and outputs a corresponding detection signal 192. User data encoded into predetermined channel codes is recorded in the data field 103. The channel decoder 25 separately decodes the channel codes to restore the original user data. The sync mark (sync pattern) is used to detect the leading position of the channel codes.

(Configuration of Timing Generation Unit 23)

FIG. 3 is a block diagram showing the configuration of the timing generation unit 23 according to the present embodiment.

The timing generation unit 23 is what is called a PLL circuit that detects a phase difference between a read signal (digital signal) and a sampling clock (timing clock) 231 for the A/D converter 17 to synchronize the phase of the clock 231 (an output from a VCO 304) to the phase of the signal.

As shown in FIG. 3, the timing generation unit 23 has an acquisition mode phase comparison unit 300, a tracking mode phase comparison unit 301, a multiplexer (MUX) 302, a loop filter 303, a voltage-controlled oscillator (VCO) 304.

The acquisition mode phase comparison unit 300 detects, in the preamble pattern (170) read by the A/D converter 17, a phase difference between the channel clock (that is, the timing clock 231) and a digital signal waveform sampled by the A/D converter 17. The acquisition mode phase comparison unit 300 performs a phase comparison operation in an acquisition mode and outputs a phase difference signal 230 to each of the MUX 302 and SYNC detection unit 20.

The tracking mode phase comparison unit 301 performs a phase comparison operation in a tracking mode and outputs a phase difference signal 230 to each of the MUX 302 and SYNC detection unit 20. Specifically, when user data is reproduced, the phase comparison unit 301 detects a phase difference between the digital signal waveform 180 PR-equalized by the digital filter 18 and the binary data sequence 190 outputted by the iterative decoder 19.

The loop filter 303 includes a frequency loop 305. In the acquisition mode, in which the preamble pattern is used, the loop filter 303 receives the phase difference signal 230 from the acquisition mode phase comparison unit 300 which signal is selected by the MUX 302. In the tracking mode, in which channel encoded data is tracked, the loop filter 303 receives a phase difference signal from the tracking mode phase comparison unit 301 which signal is selected by the MUX 302. The loop filter 303 includes amplifiers 306 and 307 each having a predetermined gain G, adders 308 and 309, and a register 400 that performs a delay function.

As shown in FIG. 4, the acquisition mode phase comparison unit 300 has registers 401 to 403, multipliers 404 to 406, and an adder 407. The registers 401 to 403 delay input data a time equal to one clock.

Since the discrete time sample data sequence from the A/D converter 17 is inputted to the phase comparison unit 300, difference information obtained from individual sample values is the amount of differences in the amplitude value. Accordingly, the phase comparison unit 300 converts the amount of differences in amplitude value into the amount of differences in the phase.

In FIG. 4, if a value outputted by the A/D converter 17 at a time k is defined as Yk, a value outputted by the register 401 and delayed one clock time is denoted by Yk−1. An ideal value of a sampling signal corresponding to the output 170 from the A/D converter 17 provided at the time k is denoted by Zk. The ideal value Zk is obtained by inverting the polarity of an output from the register 403 and is inputted to the register 402. An output from the register 402 is an ideal value Zk−1 for a sampling signal corresponding to the output 170 from the A/D converter delayed one clock time.

A preamble pattern, the output 170 from the A/D converter 17, is a single frequency signal with a period of 4 clocks. Thus, the ideal values of sampling signals corresponding to the preamble pattern are an iteration of the values “Zk, Zk−1, −Zk, and −Zk−1”. These ideal values are generated by a loop formed by the registers 402 and 403.

The phase difference between the sampling clock based on the preamble pattern and the read signal clock is calculated using the expression “((Yk−1)×Zk)−(Yk×(Zk−1) )”.

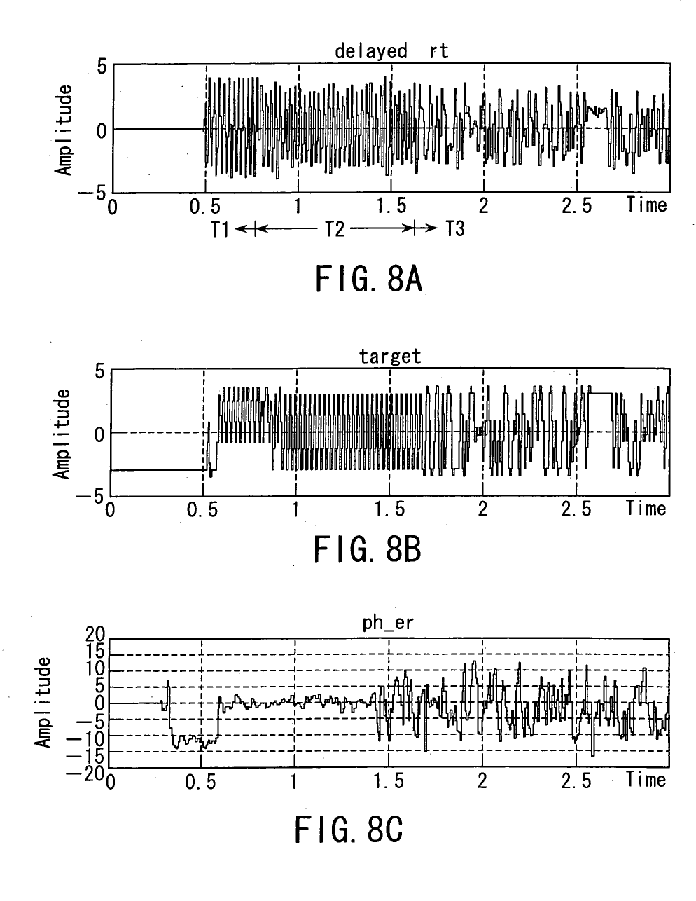

FIGS. 8A to 8C are timing charts showing specific examples of signal waveforms relating to operations of the acquisition mode phase comparison unit 300.

FIG. 8A is a timing chart showing a sample data sequence of a preamble pattern, the output 170 from the A/D converter 17. FIG. 8B is a timing chart showing the ideal values of sampling signals corresponding to the output 170 from the A/D converter 17. FIG. 8C is a timing chart showing the output 230 from the comparison unit 300.

A section T1, shown in FIG. 8A, corresponds to a section in which the read channel is initialized at the beginning of the sector. For signals in the section T1, the output 170 from the A/D converter 17 is used as an initial adjustment signal but is meaningless as data. Accordingly, the output 170 is not used as data. Furthermore, in the section T1, the acquisition mode phase comparison unit 300 does not operate.

A section T2 corresponds to the area 101 shown in FIG. 2, in which the preamble pattern is recorded. In the section T2, the phase of the read signal is synchronized to the phase of the sampling clock from the A/D converter 17. As shown in FIG. 8C, the output 230 from the acquisition mode phase comparison unit 300 in the section T2 is calculated from the sample data sequence (170) shown in FIG. 8A and the ideal values of the sampling signals shown in FIG. 8B.

A section T3 corresponds to the sync pattern recorded in the sync mark area 102 and the channel code data written in the user data area 103 as shown in FIG. 2. The timing generation unit 23, shown in FIG. 3, controls the phase of the output 231 from the VCO 304 by performing a phase difference detection operation in the section T3.

In the section T3, the acquisition mode phase comparison unit 300 compares a recorded signal having more than one frequency (sync pattern and channel code data) with a single-frequency signal with a period of four clocks generated by the loop formed by the registers 402 and 403. Consequently, the acquisition mode phase comparison unit 300 outputs a signal with a large phase difference in the section T3.

(Configuration of SYNC Detection Unit 20)

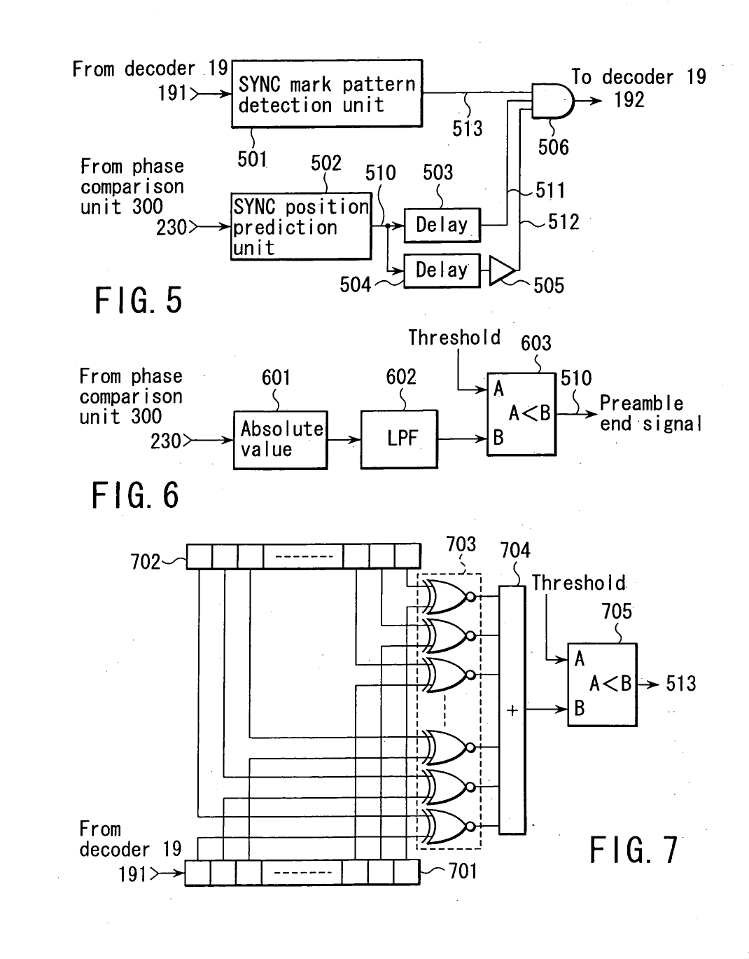

FIG. 5 is a block diagram showing the configuration of the SYNC detection unit 20 according to the present embodiment.

A SYNC mark pattern (hereinafter referred to as “SYNC pattern”) detection unit 501 receives the binary data 191 from the iterative decoder 19 and compares the binary data 191 with a sync pattern (reference pattern). The detection unit 501 transmits a sync pattern detection signal 513 to an AND gate 506.

FIG. 7 is a block diagram showing the configuration of the SYNC pattern detection section 501 in detail.

The SYNC pattern detection unit 501 has an input shift register 701, a register 702 that stores a known sync pattern (reference pattern), a gate circuit 703, an adder 704, and a comparator 705.

The shift register 701 receives the binary data 191 outputted by the iterative decoder 19 as an input and stores it. The gate circuit 703 includes a plurality of EX-OR (exclusive OR) gates and a NOT gate and outputs bits that are matched between the binary data 191 and the reference pattern. The adder 704 outputs the result of addition, that is, the number of matched bits, to an input B of the comparator 705. The comparator 705 compares a threshold set at its input A with the number of bits at its input B. If the number of bits at the input B is larger than the threshold, the comparator 705 outputs a sync pattern detection signal 513 indicating that a sync pattern (sync mark) has been detected.

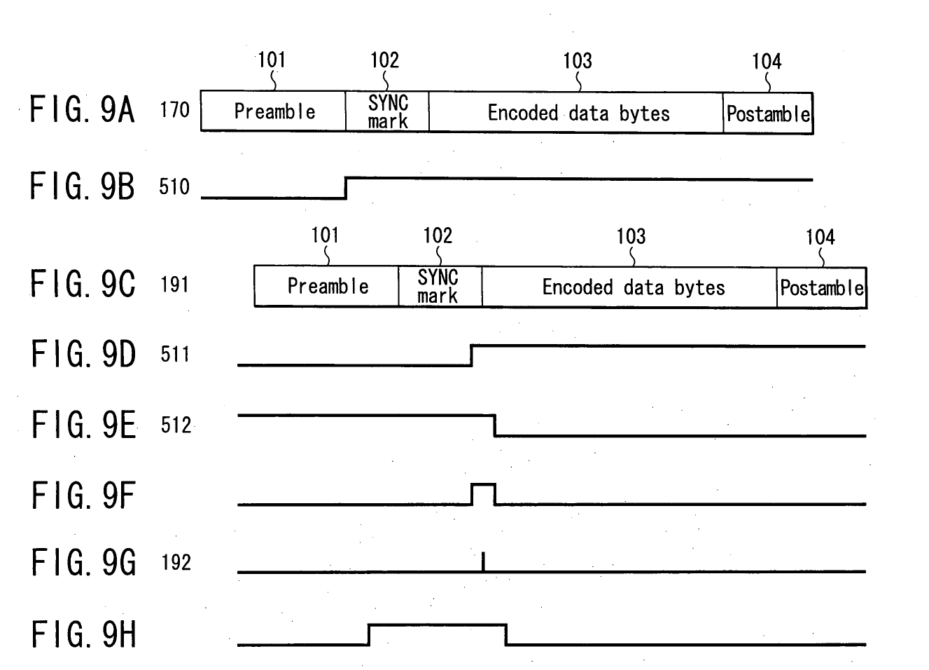

On the other hand, a SYNC position prediction unit 502 receives the output signal 230 from the acquisition mode phase comparison unit 300 (see FIG. 8C). The SYNC position prediction unit 502 outputs a detection signal 510 once the read signal switches from the preamble area 101 to the sync mark area 102 (see FIG. 9B).

As shown in FIG. 5, the output 510 from the SYNC position prediction unit 502 is inputted to delay circuits 503 and 504. An AND gate 506 receives, as inputs, an output signal 511 from the delay circuit 503 and an output signal 512 from an inverter 505 that inverts an output from the delay circuit 503. That is, each of the output signals 511 and 512 function as an enable signal (gate control signal) for the sync pattern detection signal 513, outputted by the comparator 705 of the SYNC pattern detection unit 501 (see FIGS. 9D and 9E).

For the delay circuits 503 and 504, a time equal to the sum of a delay in the digital filter 18 and a decode delay is required until a signal sampled by the A/D converter 17 is converted by the iterative decoder 19 into the binary data 191. Thus, the delay circuit 503 provides a delay equal to the sum of these delay times and the time required for a comparison of the sync pattern.

Furthermore, the delay circuit 504 has a delay amount containing a permissible detection time. A digital signal processing circuit including the digital filter 18, the iterative decoder 19, and the SYNC detection unit 20 operates on the basis of the sampling clock from the A/D converter 17, which clock synchronizes with a clock component of the read signal. Hence, these delay times serve to absorb the adverse effects of a variation in rotation, so the SYNC detection unit 20 tracks accurately the formant of recorded data.

(Configuration of SYNC Position Prediction Unit 502)

FIG. 6 is a block diagram showing the configuration of the SYNC position prediction unit 502.

The SYNC position prediction unit 502 has an absolute value conversion unit 601, a low pass filter (LPF) 602, and a comparator 603. The absolute value conversion unit 601 converts the amplitude value of the output signal 230 from the acquisition mode phase comparison unit 300 into an absolute value. The comparator 603 receives the absolute amplitude value via the LPF 602 as an input and compares the input B with the input A of the predetermined threshold. When the absolute amplitude value is larger than the threshold, the comparator 603 outputs a preamble end signal 510.

Specifically, once the section T2 of the preamble area 101 of the read signal is ended, the phase difference component (input B) contained in the output signal 230 from the acquisition mode phase comparison unit 300 increases above the predetermined threshold (input A). Consequently, the SYNC position prediction unit 520 outputs a signal predicting a transition from the preamble area 101 to the position of the SYNC mark area 102, in which the sync pattern is recorded.

(Operations and Effects of Present Embodiment)

In short, in the read channel according to the present embodiment, a read signal read by the read head is converted into a digital signal sequence (the output 180 from the digital filter). The digital signal sequence is then converted by the iterative decoder 19 into the binary data 191 (see FIG. 9C).

The SYNC detection unit 20 detects, in the binary data 191 from the iterative decoder 19, the sync pattern (sync mark) recorded in the SYNC mark area 102. On this occasion, normally, the position of the sync mark is insufficiently accurately predicted because of the adverse effects of a variation in the rotation of the disk medium. Thus, as shown in FIG. 9H, a detection window is required which covers a wide range from the preamble area 101 to the user data area 103.

On the other hand, in the SYNC detection unit 20 according to the present embodiment, the SYNC position prediction unit 502 outputs the prediction signal 510, which predicts the end position of the preamble area 101, that is, the start position of the SYNC mark area 102, as shown in FIG. 9B. On this occasion, before the binary data 191 is generated, the SYNC position prediction unit 502 uses the output signal 230 from the acquisition mode phase comparison unit 300 to accurately predict the end position (the position of the SYNC mark area 102).

Moreover, in the present embodiment, the AND gate 506 generates a detection window with a limited permissible detection range using the delay circuits 503, 504, which receive the prediction signal 510 inputted by the SYNC position prediction unit 502, as shown in FIG. 9F.

Consequently, the SYNC detection unit 20 outputs the sync pattern (mark) detection signal 192 that is effective as an enable signal, via the AND gate 506 on the basis of the sync pattern detection signal 513, outputted by the SYNC pattern detection unit 501. Thus, in accordance with the detection signal 192 from the SYNC detection signal 20, the iterative decoder 19 can decode encoded user data from the data field 103 while separating it into channel codes.

In the present embodiment, the probability of mistakes in detecting a sync mark can be kept low even in a system having a very low signal S/N in a signal processing step of detecting the sync mark, for example, in a read channel using the iterative decoder 19. In other words, according to the present embodiment, the position of a sync mark is more accurately predicted to enable the sync mark to be more accurately detected.

(Other Embodiments)

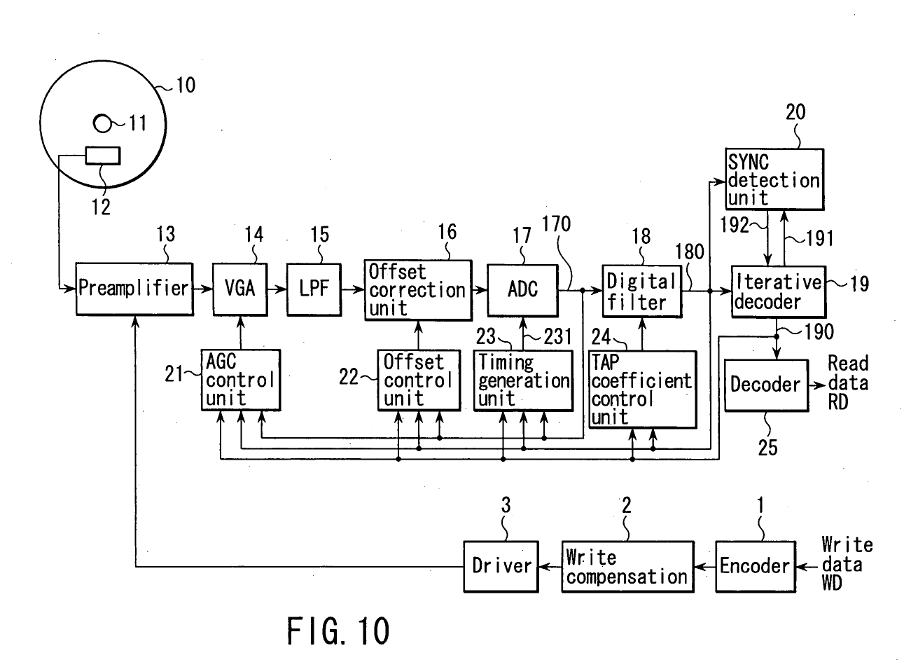

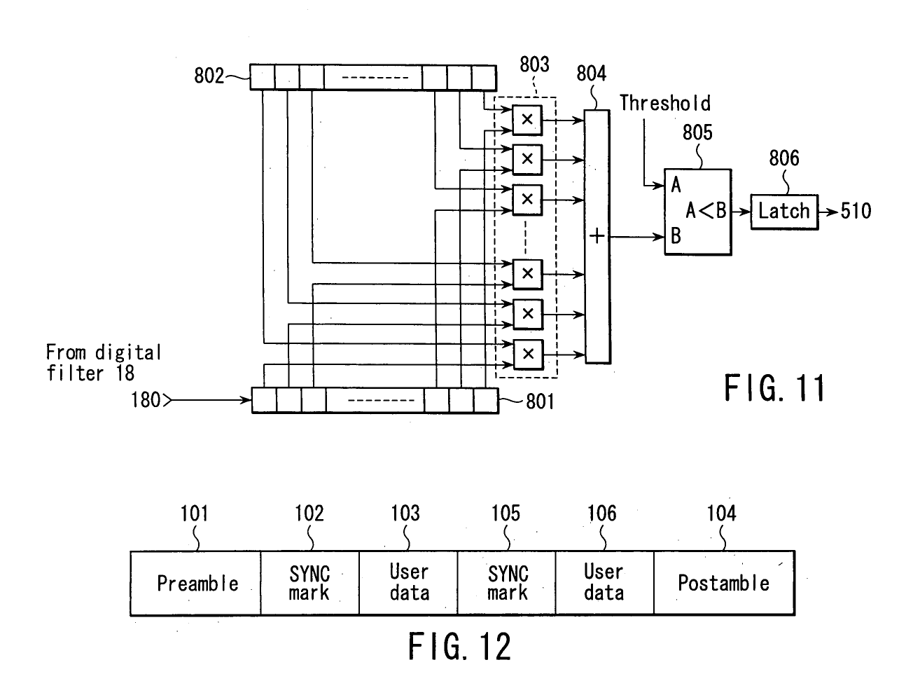

FIGS. 10 and 11 are block diagrams of a disk drive according to another embodiment.

In the present embodiment, as shown in FIG. 10, the SYNC detection unit 20 is supplied with the output signal 180 from the digital filter 18. The other arrangements of the read channel are similar to those shown in FIG. 1 for the present embodiment. Thus, their description is omitted.

FIG. 11 is a block diagram showing the configuration of a SYNC position prediction unit included in the SYNC detection unit 20 according to the present variation. This SYNC position prediction unit has an input shift register 801, a register 802 that stores a preset reference pattern, a gate circuit 803, an adder 804, a comparator 805, and a latch circuit 806.

The shift register 801 receives and stores, as an input, an equalized waveform sequence outputted by the digital filter 18. A gate circuit 803 is composed of a plurality of EX-OR (exclusive OE) gates and outputs bits that are matched between the equalized waveform sequence 180 and a reference pattern.

The adder 804 outputs the result of an addition, that is, the number of matched bits, to an input B of the comparator 805. The comparator 805 compares a threshold set at its input A with the number of bits at its input B. If the number of bits at the input B is larger than the threshold (A<B), the adder 804 outputs the pattern detection signal 510, indicating that a sync pattern (sync mark) has been detected. The latch circuit 806 latches the sync pattern detection signal 510.

Here, the sync pattern (sync mark) recorded in the SYNC mark area 102 is composed of a predetermined bit sequence. Consequently, by setting a known sync pattern in the register 802, it is possible that the comparator 805 detects whether or not the equalized waveform sequence 180, resultingly outputted by the digital filter 18, is a sync pattern.

In short, according to the present embodiment, the SYNC position prediction unit, contained in the SYNC detection unit 20, receives as an input the equalized waveform sequence 180, outputted by the digital filter 18, to accurately detect the sync pattern. The SYNC position prediction unit thus predicts the end position of the preamble area 101 (the position of the SYNC mark area 102).

The arrangements in the SYNC detection unit 20 other than the SYNC position prediction unit are similar to those shown in FIG. 5. Accordingly, the SYNC detection unit 20 outputs the sync pattern (mark) detection signal 192 that is effective as an enable signal, via the AND gate 506 on the basis of the sync pattern detection signal 513, outputted by the SYNC pattern detection unit 501. Thus, in accordance with the detection signal 192 from the SYNC detection signal 20, the iterative decoder 19 can decode encoded user data from the data field 103 while separating it into channel codes.

(Other Embodiments for Sector Format)

FIG. 12 shows a format having the first SYNC mark area 102, in which a sync pattern is recorded, and a second SYNC mark area, in connection with the sector format according to the present embodiment shown in FIG. 2.

In a disk drive employing the present sector format, if the read channel fails to detect the sync pattern in the first SYNC mark area 102 using the SYNC detection unit 20 during data reproduction, it attempts to detect the sync pattern in the second SYNC mark area 105.

Once the read channel detects the sync pattern in the second SYNC mark area 105, it starts decoding every channel code from the subsequent data field (user data area) 106. Thus, in this case, the data field 103, located adjacent to the first SYNC mark area 102, cannot be decoded. Accordingly, this data is restored using an error correction code (ECC).

As described above, with the present sector format, even if the sync pattern in the first SYNC mark area 102 cannot be detected, the data can be reproduced by detecting the sync pattern in the second SYNC mark area 105.

However, if the sync pattern in the first SYNC mark area is mistakenly detected, decoding is carried out using the incorrect leading position of the channel codes in the data field 103. In this data reproduction operation, the error cannot be corrected.

Thus, even in the disk drive employing the present sector format, the SYNC detection system according to the present embodiment is applied to reduce the probability of mistakenly detecting the sync pattern in the first SYNC mark area 102. This enables the data to be accurately reproduced.

In short, as described above, the SYNC position prediction unit uses the digital signal sequence (170 or 180) present before generation of binary data from a read signal, to predict the end of the preamble pattern or the leading position of the sync pattern. Consequently, the sync pattern (sync mark) can be more accurately detected. In other words, even in a read channel that processes a read signal with a low S/N, it is possible to reduce the rate of mistaken detection of a sync pattern in the SYNC mark area 102.

Therefore, by applying the present invention to a disk drive that decodes user data on the basis of the sync marl (sync pattern) contained in the read signal, it is possible to more accurately predict the position of the sync mark. As a result, the sync mark can be more accurately detected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive comprising:
a disk medium;
a read head which reads a read signal from the disk medium, the read signal containing data recorded in a data field on the disk medium and a sync pattern used to detect a leading position of the data field;
a binary data generation unit which generates a binary data sequence from the read signal, the binary data sequence corresponding to the data and the sync pattern; and
a sync detection unit which uses the read signal to determine the leading position of the sync pattern and detects the sync pattern in the binary data sequence in accordance with a result of the detection.

2. The disk drive according to claim 1, further comprising:
a read channel which processes the read signal to reproduce data and which includes the binary data generation unit and the sync detection unit.

3. The disk drive according to claim 1, further comprising:
a decoding unit which decodes the data from the binary data sequence in accordance with a detection signal for the sync pattern from the sync detection unit.

4. The disk drive according to claim 1, wherein the sync detection unit includes a prediction unit which determines the leading position of the sync pattern, and
the prediction unit outputs a determination signal indicative of the leading position when an amplitude value of the read signal indicates a preset expected value.

5. The disk drive according to claim 1, wherein the sync detection unit includes a unit which compares the binary data sequence with a reference data sequence corresponding to the sync pattern and which generates a detection signal for the sync pattern when a result of the comparison indicates that the data sequences are matched, and
an output control unit which provides such control as outputs the detection signal for the sync pattern in accordance with the result of determination indicative of the leading position of the sync pattern.

6. The disk drive according to claim 4, wherein the sync detection unit includes a unit which compares the binary data sequence with a reference data sequence corresponding to the sync pattern and which generates a detection signal for the sync pattern when a result of the comparison indicates that the data sequences are matched, and
an output control unit which provides such control as outputs the detection signal for the sync pattern using the determination signal outputted by the prediction unit and indicating the leading position of the sync pattern.

7. A disk drive comprising:
a disk medium on which a sector format including a preamble area, sync mark area, and a data field is formed;
a read head which reads a read signal from the sector format on the disk medium; and
a read channel which processes the read signal to reproduce data, the read channel including:
a binary data generation unit which generates, from the read signal, a binary data sequence corresponding to data recorded in the data field and a sync pattern recorded in the sync mark area; and
a sync detection unit which detects the sync pattern in the binary data sequence, which includes a prediction unit generating an end signal for the preamble area in order to determine the leading position of the sync pattern using the read signal, and which outputs a detection signal for the sync pattern in accordance with the end signal for the preamble area.

8. The disk drive according to claim 7, wherein the read channel includes, in front of the binary data generation unit, a timing signal generation unit which generate a timing signal required for a data reproduction process, from a part of the read signal corresponding to the preamble area, and
wherein the prediction unit generates the end signal for the preamble area using the signal outputted by the timing signal generation unit.

9. The disk drive according to claim 7, wherein the read channel includes, in front of the binary data generation unit, a timing signal generation unit which generate a timing signal required for a data reproduction process, from a part of the read signal corresponding to the preamble area, and
an A/D converter which converts an analog signal waveform of the read signal into a digital signal,
wherein the timing signal generation unit includes a phase difference detection unit which receives the digital signal outputted by the A/D converter as an input to detect a phase difference between the timing signal required for the data reproduction process and the part of the read signal corresponding to the preamble area, and
wherein the prediction unit generates the end signal for the preamble area using a phase difference detection signal outputted by the phase difference detection unfit.

10. The disk drive according to claim 7, wherein the read channel includes, in front of the binary data generation unit, an A/D converter which converts an analog signal waveform of the read signal into a digital signal, and
a digital equalization unit which receives the digital signal outputted by the A/D converter as an input and executes a digital waveform equalization process, and
wherein the prediction unit generates the end signal for the preamble area using a signal outputted by the digital equalization unit.

11. The disk drive according to claim 7, wherein the sync detection unit includes a unit which compares the binary data sequence with a reference data sequence corresponding to the sync pattern and which generates a detection signal for the sync pattern when a result of the comparison indicates that the data sequences are matched, and
an output control gate which provides such control as outputs the detection signal for the sync pattern in accordance with the end signal for the preamble area outputted by the prediction unit.

12. The disk drive according to claim 9, wherein the prediction unit compares an amplitude value of the phase difference detection signal outputted by the phase difference detection unit with a present expected value and outputs the end signal for the preamble area when the amplitude value indicates the expected value.

13. The disk drive according to claim 10, wherein the prediction unit compares a digital signal sequence outputted by the digital equalization unit with a prepared reference digital signal sequence corresponding to the end signal for the preamble area, and outputs the end signal for the preamble area in accordance with a result of the comparison.

14. A method of detecting a sync mark, the method comprising:
in a disk drive including a disk medium and a read head which reads, from the disk medium, a read signal containing data recorded in a data field on the disk medium and a sync pattern used to detect a leading position of the data field,
generating a binary data sequence corresponding to the data and the sync pattern, from the read signal;
using the read signal to determine a leading position of the sync pattern; and
outputting a detection signal for the sync pattern from the binary data sequence in accordance with a result of the determination of the leading position of the sync pattern.

15. A method according to claim 14, further comprising decoding the data from the binary data sequence in accordance with the detection signal for the sync pattern.

16. A method according to claim 14, wherein the binary data sequence is compared with a reference data sequence corresponding to the sync pattern, and a detection signal for the sync pattern is generated when a result of the comparison indicates that the data sequences are matched, and
wherein the detection signal for the sync pattern is outputted using a determination signal indicative of the leading position of the sync pattern.

17. A method according to claim 14, further comprising generating an end signal for a preamble area on the disk medium in order to determine the leading position of the sync pattern using the read signal, and
outputting the detection signal for the sync pattern in accordance with the end signal for the preamble area.

18. A method according to claim 17, further comprising:
before the process of generating the binary data sequence, generating a timing signal required for a data reproduction process, from a part of the read signal corresponding to the preamble area, and
generating the end signal for the preamble area using the timing signal.

19. A method according to claim 17, further comprising:
before the process of generating the binary data sequence, converting an analog signal waveform of the read signal into a digital signal,
receiving the digital signal as an input and executing a digital waveform equalization process; and
generating the end signal for the preamble area using a digital signal sequence obtained by the digital waveform equalization process.
